(19) United States
(12) Patent Application Publication
(10) Pub. No.: US 2008/0063771 A1
(43) Pub. Date: Mar. 13, 2008

(54) Heat exchanger unit

(76) Inventor: Richard H. Dumm, Windsor, CO (US)

Correspondence Address: JAMES K. POOLE, ESQ., P.O. BOX 925, LOVELAND, CO, 80539, US

(21) Appl. No.: 11/519,758

(22) Filed: Sep. 12, 2006

(51) Int. Cl. A23L 3/06

(52) U.S. Cl. 426/522; 165/102; 165/46

(57) ABSTRACT

A flexible heat exchange jacket is provided which has channels for flow of a heat exchange fluid along one side, with inlets and outlets attached to a source of heat exchange fluid. The jacket can be attached in a watertight manner around the circumference of a cylindrical process container containing a liquid for heat treatment. Preferred embodiments include devices for heating and/or cooling the heat exchange fluid prior to entering the jacket, mixers for the liquid under treatment within the container, and heaters for the liquid within the container and/or the bottom of the container itself. A dairy pasteurizer version combines a cylindrical process container with a heat exchange jacket installed around its exterior with heating and refrigeration units for the heat exchange fluid, heat sensing and mixing devices, and a control system programmed to execute a pasteurization cycle.

### REFERENCE TO RELATED APPLICATIONS

This application is related to Applicant's U.S. Pat. No. 6,276,264 for PORTABLE BATCH PASTEURIZER and to U.S. Ser. No. 10/923,331, published as US2005/0103213, for BATCH PASTEURIZER, now U.S. Pat. No. ______, although not claiming priority from either. This patent and pending application are incorporated herein by reference in their entireties.

### BACKGROUND

1. Field of the Subject Matter

The present embodiments pertain to apparatus for transferring heat, i.e., heating ans/or cooling liquids in containers.

2. Discussion of Relevant Art

Many systems have been devised over the years to provide indirect heating for milk and other heat-sensitive products, such as double boilers, steam-jacketed kettles and the like. Similarly, various means for cooling liquids or other heated foodstuffs in containers are available, including the placing of such containers in refrigerated spaces or simply placing a heated bucket into a cooler liquid. Creating combinations of containers, heating and cooling means to optimize the heating and cooling of liquid and slurry materials is a continuing quest.

Extensive summaries of relevant art in the pasteurizer and heat exchanger art are listed in the background sections of Applicant's above patent and application, which are incorporated by reference herein.

Despite all the systems extant for heating, pasteurizing and cooling various liquid and slurry materials in containers, the need remains for a compact means of contacting heat-permeable containers of various materials with flowing heat exchange fluids to provide fast and efficient heating and/or cooling treatments.

### SUMMARY OF THE INVENTION

It is an aspect of the present embodiments to provide heat exchange apparatus which are effective in the transfer of heat between fluids within containers and heating and/or cooling fluids which are applied to the exterior of such containers. Another aspect is to provide a flexible heat exchange jacket comprising channels along one side for the circulation of heating/cooling fluids, the jacket being adapted to be fastened securely to the circumference of a container of liquid so as to allow the heating/cooling fluid to circulate in direct contact with the outer surface of the container. Another aspect is the provision of heating and/or cooling means for heating/cooling fluids to be circulated through the channels in the heat exchange jacket. Still another aspect is the use of temperature sensing means to measure the temperature of liquid within the container and control means to facilitate the heating and/or cooling of the liquid within a container to at least one desired temperature, and to maintain such temperature(s) indefinitely or for predetermined periods of time. A complementary aspect is the provision of mixing or circulation means for liquid within the container to expedite the heating or cooling of the liquid. An aspect of certain embodiments is to configure and control the apparatus to pasteurize liquids such as dairy products or other food products in containers. Additional heating means, both internal (submerged within the fluid treated) and external (e.g., heater(s) at the bottom of the container) can be provided to augment the heat exchange means disclosed herein.

Another aspect of certain embodiments is to provide control means for heating and/or cooling means which can closely control the temperatures and time periods at various temperature levels for processes such as pasteurization which are dictated by increasingly exacting requirements which are dictated by advancing scientific research. An aspect of this objective is to attain faster, more efficient and responsive heat exchange by employing flowing heat exchange fluids in direct contact with the exterior of the process container. A further aspect is to employ heat exchange jackets which provide such flows of heat exchange fluids while also insulating the exterior of the process container. A related aspect is to provide channels for flow of heat exchange fluids within such heat exchange jackets to optimize the flow of heat exchange fluid and thus increase the rate and efficiency of heat exchange. Such heat exchange fluids can be circulated through these channels by any suitable means, including pumps, normal pressurized water sources and gravitational systems. Another related aspect is to provide heat exchange jackets which are flexible and fabricated of materials which permit watertight attachment to process containers in conformance with their exterior shapes and surface properties.

Certain of these objects and aspects are attained by various embodiments described below. One embodiment comprises a sheet of a flexible material having at least one set of inlet and outlet means connected by fluid channels impressed in an inner side of the sheet, the channels being arranged and having suitable capacity to permit flows of the heating/cooling fluid within the channels and directly against the outside surface of a liquid-container to optimize heat transfer between the heating/cooling fluid, the container and the liquid within. Preferably, the channels are configured to allow laminar flow of the heating/cooling fluid through the channels and against the container outer surfaces when the jacket is attached around the circumference of the container. The jacket is configured to permit securing of opposite ends together after it is tightly wrapped about the container with the fluid channels inward. The jacket can also be configured to be attached, sealed or otherwise melded together to form an open cylinder which can then be slid over the external surface of the container to provide close adherence to the container, preferably with mechanical attachments to the container. The channels can describe various serpentine patterns to allow flow from one edge of the jacket to the other, thus directly contacting the container surface and transferring heat from the treated liquid within to the heat exchange fluid. In an embodiment, the channels can be configured to match as opposite ends of the jacket are connected around the container, then describing a helical pattern from one side of the jacket to the other and permitting continuous flow from one edge to the other without abrupt changes in direction.

Preferred embodiments provide a container for the processing of liquids, having a substantially round cross section and cylindrical form, mounted in a unit which combines the container, a heat exchange jacket, a source of heating and/or cooling fluid, control means for the unit and mixing means for the fluid processed. The source of heating and/or cooling fluids comprises a reservoir or vessel containing a heat exchange fluid, means for heating and/or cooling the fluid and pumping means to circulate the heat exchange fluid at the desired temperature into the heat exchange jacket (where the fluid circulates through the fluid channels and against the outer surface of the container filled with liquid being processed) and back to the reservoir. A preferred embodiment provides a refrigeration unit which provides chilled heat exchange fluid. Various embodiments include control means adapted and programmed to produce a variety of functions, ranging from simple heating or cooling of the processed liquid to pasteurization cycles for various types of liquids or slurries requiring such treatment. Temperature sensing means are provided to detect and maintain proper set temperatures for the heat exchange fluid and processed liquid. Stirring means are provided to circulate the treated fluid within the container to expedite heat exchange and make the temperature of the treated fluid as uniform as possible. Stirring means can include motor-driven drive shafts carrying at least one propeller, impeller or the like. A preferred embodiment comprising a hollow shaft coupling which is mechanically attached to the motor drive shaft and contains a slot along the side thereof which permits the drive shaft to be inserted into the housing from the side and then screwed into interior threads or otherwise mechanically attached for use.

### BRIEF DESCRIPTION OF THE DRAWINGS

The objects and advantages of the present embodiments will be further understood by perusal of the following detailed description, the appended claims, and the drawings, in which:

FIG. 1 is a perspective view of an embodiment of a heat exchange jacket revealing a heat exchange channels and connections for intake and discharge of heat exchange fluids;

FIG. 1A is a plan view of the inner surface of a heat exchange jacket comparable to that of FIG. 1, illustrating a helical pattern of heat exchange channels;

FIG. 2 is a perspective view of the jacket of FIG. 1 illustrating an alternate pattern of heat exchange channels;

FIG. 3 is a plan view of the jacket of FIG. 2 illustrating the complete pattern of serpentine heat exchange channels;

FIG. 4 is a plan view of the reverse side of the jacket of FIG. 1;

FIG. 5 is a perspective view of the jacket of FIG. 1 secured to form an open cylindrical shell with the heat exchange channels inside;

FIG. 6 is a sectional view of the jacket of FIG. 1 showing channels having cross sections of various shapes;

FIG. 7 is a front perspective view of a complete assembled pasteurization apparatus with an enclosure case;

FIG. 8 is a rear perspective view of the unit of FIG. 7;

FIG. 9 is a side perspective view of the unit of FIG. 7 with the enclosure case removed to reveal the liquid container and a refrigeration unit;

FIG. 10 is a rear perspective view of the unit of FIG. 7 with a back panel removed;

FIG. 11 is a top perspective view of the unit of FIG. 7;

FIG. 12 is a detailed rear perspective view of the unit of FIG. 7 revealing electrical and control components;

FIG. 13 is a perspective view of the refrigeration unit component of the unit of FIG. 7.

FIG. 14 is a side perspective view of the motor and drive shaft assembly; and

FIG. 15 is a side perspective view of the shaft coupling assembly.

Further graphical details of the apparatus disclosed are provided in the parts list attached as Appendix A and the attached 3.5″ disk (Appendix B) containing electronic versions of these and other drawings.

### DETAILED DESCRIPTION OF PREFERRED EMBODIMENTS

Firstly, the embodiments described herein may be described as having upper and lower surfaces or first and second surfaces. These embodiments will be described in terms of apparatus only or installed for use as system components, and in a terrestrial field of reference wherein “upper” signifies a direction away from the surface of earth and the gravitational force and “lower” signifies the opposite direction. Where used, the expression “and/or” is used in the sense of A, B or A+B. The term “circular” is used to mean an edge or contour having a uniform radius of curvature. Where used, the terns “inner” and “outer” or similar expressions relate to the orientation of the disclosed heat exchange jackets relative to the containers about which they are used.

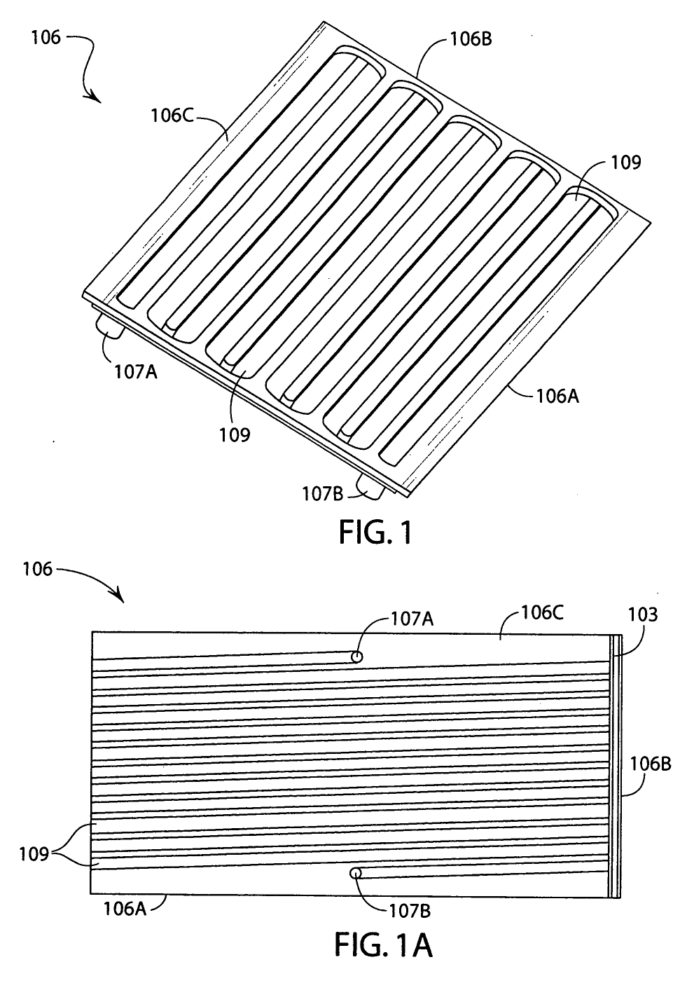

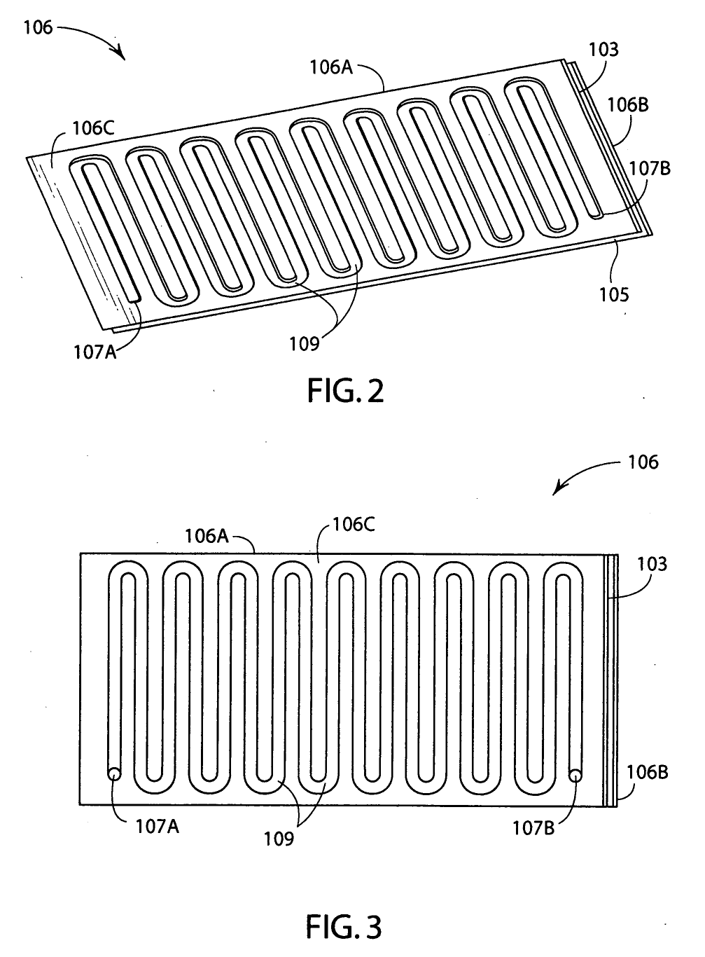

Turning now to the drawings, FIG. 1 shows a perspective view of an embodiment of a heat exchange jacket 106 of a flexible material which is waterproof and insulating, with the inlet and outlet means 107B and 107A and heat exchange fluid channels 109 visible. For convenience, the longer edges 106A will be denominated “sides” and the shorter edges 106B “ends,” with one side normally designated as the “top” side when the jacket is installed. The surface containing the fluid channels will be considered the inner surface 106C and the opposite surface the outer, 106D (not seen here). Jacket 106 is designed to heat the liquid contents of a heat-permeable container by indirect heat exchange.

In operation, the jacket is fastened securely about at least a portion of the circumference of the container, and tends to fit closely to its surface because of its construction of a rubbery material which is elastic and tends to conform to the surface. The jacket can be secured mechanically to the container by any suitable means, such as elongated worm-gear clamps 142 (known as “hose clamps” in smaller sizes), as shown below, and may also be overwrapped with adhesive tape or polymer films of various types. Covers of other materials comprising sheet metal or closed cell polymer foams can also be used to fasten the jacket to the container and provide extra insulation. Briefly, a heat exchange fluid (normally a liquid, not shown) enters through at least one inlet 107B and passes through the complete system of channels 109, reversing course multiple times at the sides 106B before exiting through outlet 107A. The heat exchange fluid is provided at the desired temperature from a source having heating and/or cooling functions, and can be recycled to the source for restoration of the desired temperature and recirculation through jacket 106.

In addition to channeling heat exchange fluids along the exterior surface of the vessel it surrounds, the jacket 106 also provides considerable insulation for the system. For example, in the systems disclosed herein, the jacket insulates the container while its contents are heated to a desired temperature, preventing significant heat loss before heat exchange fluids are employed to cool the treated contents, and thereafter to stabilize the end temperature. The jacket can serve as a protective blanket and/or cosmetic blanket for the vessel, and even a protective wrap preventing operators from direct contact with the potentially hot surfaces of the vessel during or after a heating process. The jacket may also be marked on its exterior with the manufacturer's logos, technical information, warnings or the like, as appropriate to individual applications.

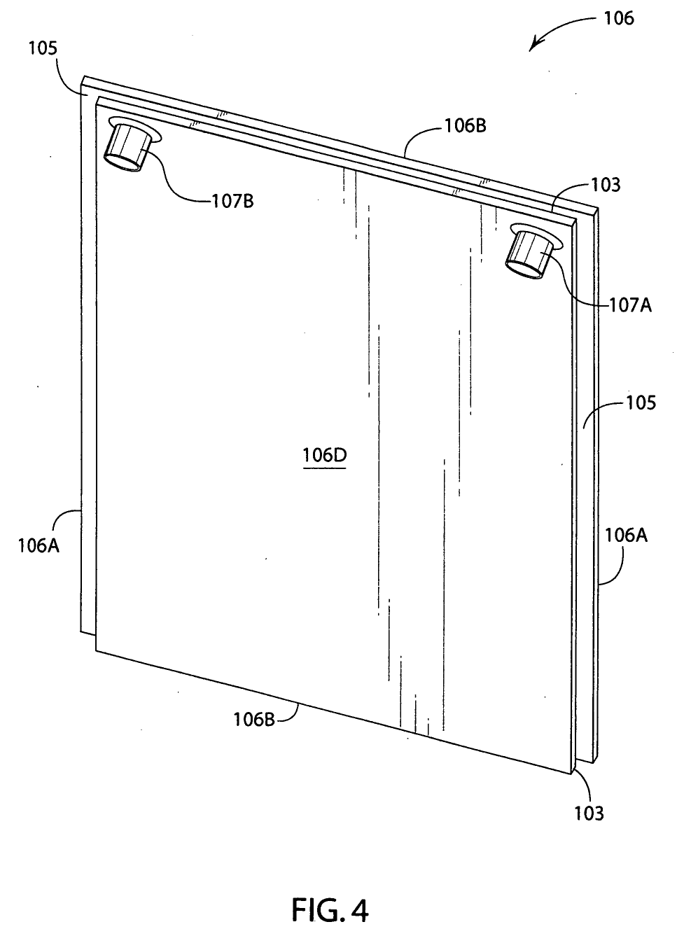

FIG. 2 provides a detailed view of the fluid channels 109 which are molded or otherwise impressed into the inner surface 106C of the jacket, passing substantially parallel with the ends 106B of the jacket and reversing direction in a serpentine fashion near the sides 106A of the jacket. The fluid thus passes in a substantially vertical pattern when installed on a container, as compared with the substantially horizontal pattern described above and illustrated in FIG. 1. Each end of this serpentine pattern of fluid channels 109 is connected to tubular inlet/outlet means 107B/107A extending to the outer surface 106D of the jacket (not shown here). These connections (at least one each for inlet and outlet purposes) can be used interchangeably as inlet or discharge connections, depending upon how the jacket is installed on the container for the liquid to be processed or treated.

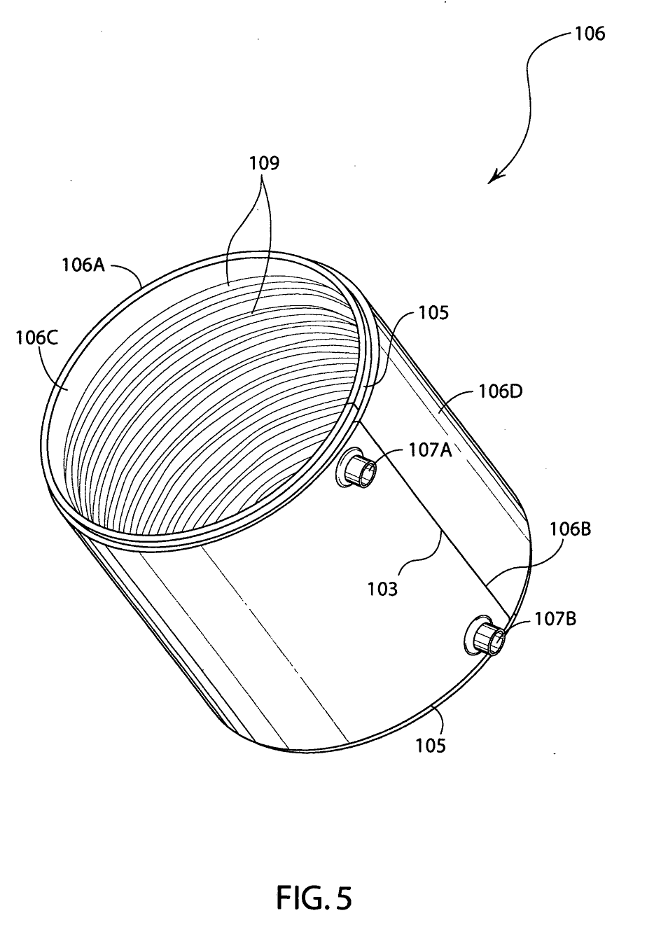

FIG. 3 provides a detailed view of fluid channels 109 in the jacket of FIG. 2, which pass substantially parallel with the ends 106B of the jacket, reversing direction in serpentine fashion near the sides 106A of the jacket. In both versions, the heat exchange fluid can be pumped from bottom to top or top to bottom of jacket 106, depending upon the process requirements. The entry points of inlet 107B and outlet 107A are shown entering channels 109. Alternative embodiments could provide a substantially unobstructed space on the inner surface 106C of jacket 106 or multiple serpentine paths along inner surface 106C, each served by its own inlet and discharge connections (not shown.)

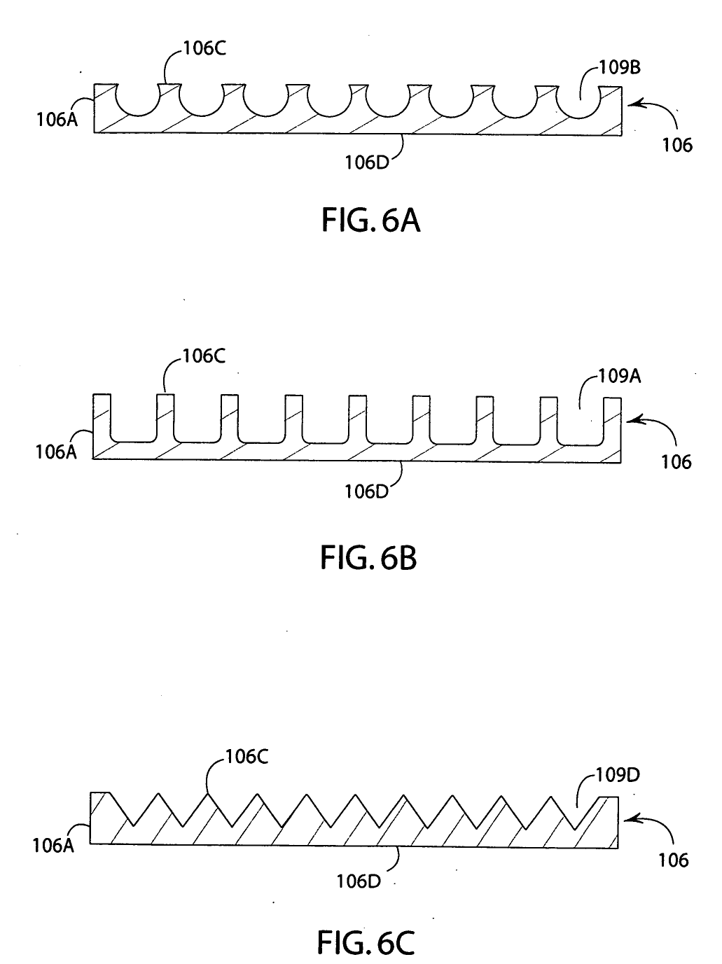

FIG. 4 shows the smooth outer surface 106D of the jacket 106, with inlet/discharge connections 107B/107A protruding. One groove 103 is visible on end 106B, and a similar groove 103 is located at the other end 106B on inner surface 106C (not visible here). Grooves 103 interlock to facilitate the secure connection of ends 106B of jacket 106. Grooves and/or ridges 105 are also provided along both sides 106A on outer surface 106D of jacket 106 to facilitate the placement of elongated worm clamps 142 when used to secure the jacket in place (illustrated and discussed below). FIG. 4 illustrates the outer surface 106D of cooling jacket 106, including intake 107B and discharge 107A connections and groove 103 along end 106B on outside surface 106D near these connections. A similar groove 103 is found on the inner surface 106C at the opposite end 106B. Grooves 103 are used to fasten the opposite ends 106B of jacket 106 together to form a secure and watertight seal around the container within the cylindrical shell of jacket 106.

While the channel patterns shown in FIGS. 1, 2 and 3 are expected to be functional, other arrangements or patterns as described above can be used to optimize the flow of heating/cooling fluids and/or heat transfer. The heat exchange fluids can be circulated through the channels by various pumps, normal pressurized water sources or gravitational systems. Preferably, these channels are arranged, shaped and have smooth inner surfaces to promote substantially laminar flow through the channels and optimize heat transfer. Alternatively, knobbed or finlike protrusions (not shown) can be molded into the surfaces of channels 109 to slow the flow of the heat exchange fluid through jacket 106.

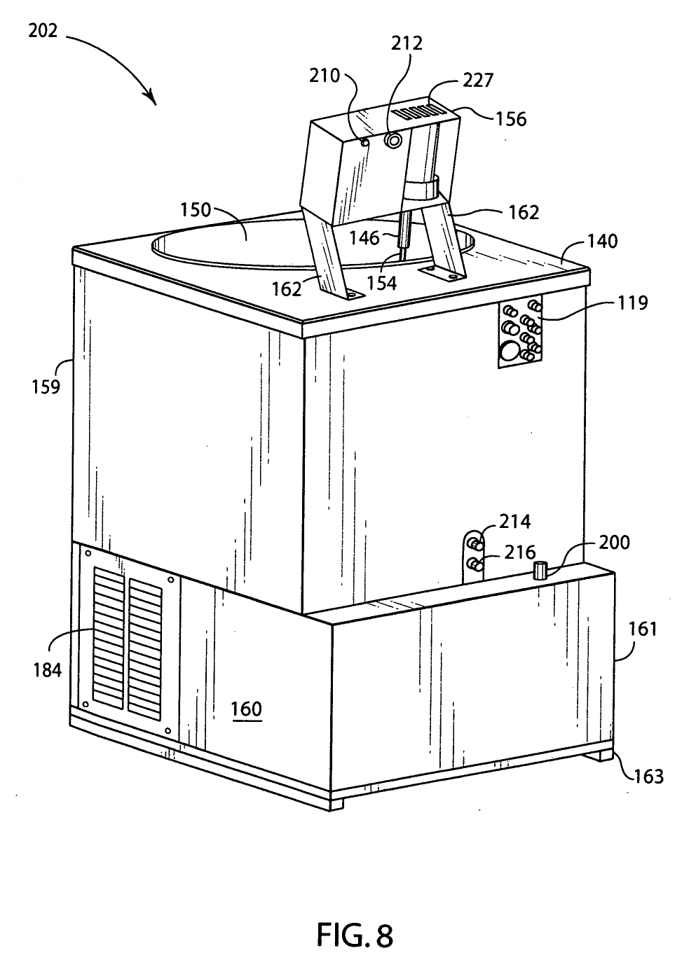

FIG. 6 is a sectional view of the jacket of FIG. 2 illustrating different possible cross sections for channels 109, e.g. square channel with rounded corners 109A, rounded channel 109B, oval channel 109C (not shown) and V-channels 109D, which can form a sawtooth cross-sectional pattern as shown or be separated by portions of inner surface 106C of jacket 106 as shown for channels 109A and 109B. The size (i.e., cross sectional area), shape and interior finish of channels 109 can be molded into jacket 106 according to process requirements and the volume and type of flow desired.

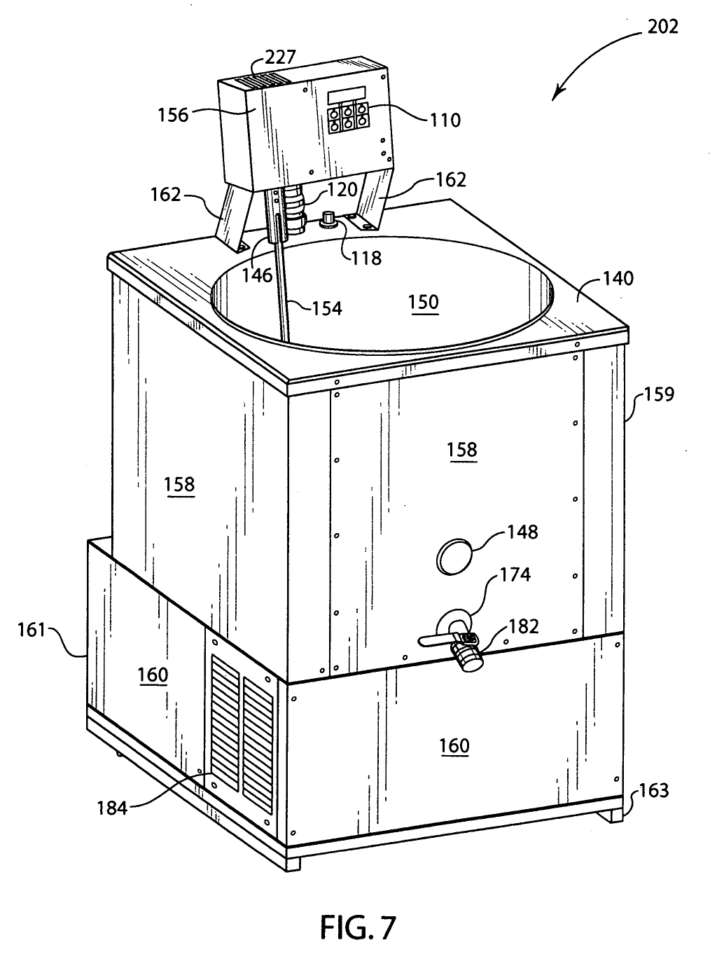

FIG. 5 illustrates the jacket 106 of FIG. 1 with ends 106B mechanically secured with interlocking grooves 103 (not visible here) to form an open cylindrical shell with the heat exchange channels 109 inward, as the jacket would be arranged around a container for heat exchange purposes. The ends 106B of jacket 106 can be secured together using interlocking grooves 103 by any suitable mechanical means, including adhesives suitable for the jacket material and operating temperatures, direct thermal bonding or vulcanization of rubber materials used for jacket 106, mechanical clamps, lacing materials or other methods known in the art (not shown.) FIG. 5 illustrates jacket 106 formed into a cylindrical form with outer surface 106D outward and inner surface 106C with channels 109 inside. Grooves and/or ridges 105 along edges 106A are provided to facilitate fastening the jacket into place on a container, as discussed above. Ends 106B of jacket 106 are secured together using interlocking grooves 103 as discussed above. In certain embodiments (See FIG. 1A.) channels 109 can be molded to extend to grooves 103 so that they meet at opposite ends 106B when jacket 106 is secured in its cylindrical form. While this may require more care to install on the container and prevent leaks, the channels can then be molded to form at least one helical or other pattern extending between the edges 106A of jacket 106 when installed to eliminate the requirement for abrupt changes in direction for the heat exchange fluid and provide fuller contact with the container surface.

Jacket 106 is formed of a resilient, rubbery material which can be attached permanently or temporarily to the surface of a treatment container of substantially round cross section to form a watertight seal which keeps the heating/cooling fluid within the channels 109 during operation. A preferred embodiment has used molded Buna rubber for the jacket, but any rubber or polymeric material having the desired properties (including elasticity, sealing ability, resistance to decomposition by the heating/cooling fluid and atmospheric conditions) can be used. As with rubber for auto tires, the materials can be compounded to provide the desired balance between elasticity and hardness, according to the process requirements. The jacket 106 is normally attached to the container (after being positioned correctly) by mechanical means such as strong elastic bands, metal straps, large metal cable clamps 142 or the like. Suitable industrial adhesives or sealing compounds can be used on at least a portion of the inner surface of the jacket to provide a better seal and/or to make the installation more permanent. Normally jacket 106 is designed to fit around the circumference of a treatment container, preferably being secured by fastening ends 106B together with grooves 103 interlocking, but with ends 106B overlapping if necessary. Two or more jackets could be used end-to-end to cover larger containers, being fastened in place by any suitable means.

As discussed below in an operational embodiment, the rate of flow of heat exchange fluid through channels 109 of jacket 106 is controlled by factors including the fluid pressure applied (which can be controlled by valves or similar means—including on-off control, variable port size and the like), channel size, shape, and interior finish; the pattern(s) of channels 109 in jacket 106 and back pressure as heat exchange fluid returns to its source.

Container 150 for treated liquids are preferably of a substantially cylindrical shape because of the ease of applying the heat exchange jacket, but can have other geometrical cross sections. The container materials should be compatible with the foodstuffs, chemicals or other materials treated therein, and should have good heat conducting properties. Generally, stainless steel and other noncorrosive alloys thereof, aluminum and various alloys thereof, and internally-tinned copper are suitable, but other materials may be suitable and cost effective for particular applications. For example, various plastics as disclosed in column 5 of U.S. Pat. No. 6,276,264 may be suitable, albeit generally lacking the superior heat conducting properties of metals. The size and capacity of the container are limited only by the particular application(s), with the heat exchange jacket(s) and other components described below sized accordingly. Embodiments for dairy applications using 10 and 30 gallon containers have been successfully tested.

Various foodstuffs and dairy products can be treated in embodiments of the apparatus disclosed herein, including milk and other dairy products, juices from fruits or concentrates, and any other types of food products which require heat treatment for safe consumption or cooking. See also the food products of various viscosities disclosed in the paragraph bridging columns 4/5 of U.S. Pat. No. 6,276,264. Furthermore, the disclosed apparatus can be used in many other processes which require heat exchange, such as exothermic chemical reactions, mixing processes, epoxy temperature control, and various oils or other products which must be maintained above or below ambient temperatures.

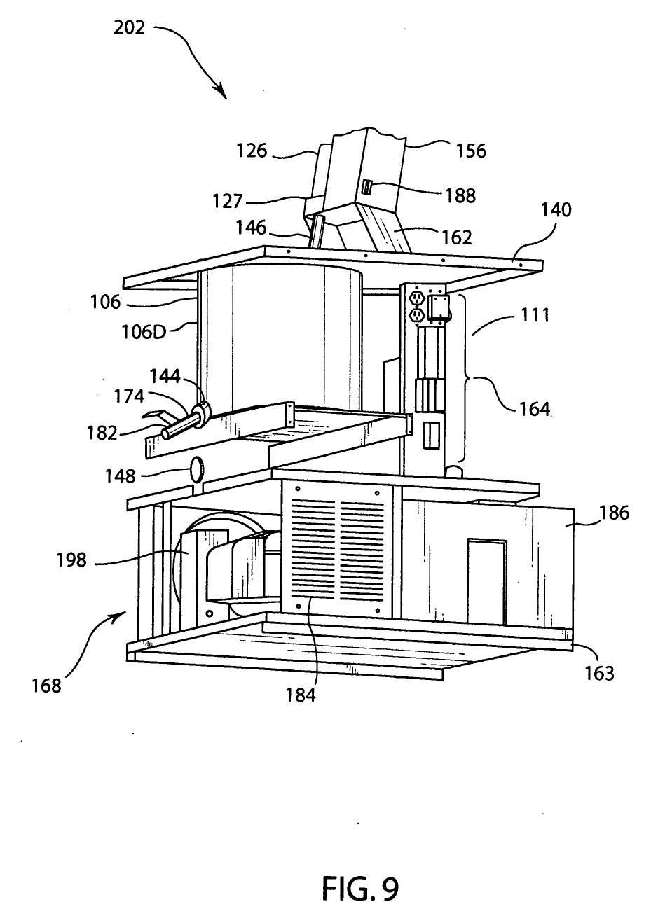

FIGS. 7 through 13 illustrate apparatus for employing a heat exchange 106 jacket described above installed around a round cylindrical container 150 for heating, cooling, pasteurizing or the like. FIG. 7 illustrates apparatus 202 which comprises a refrigeration cabinet 161 with panels 160 as its base. At least one filter screen 184 for intake and exhaust air is provided in the refrigeration cabinet 161. Upper cabinet 159 with panels 158 encloses product pot or container 150. Upper cabinet 159, refrigeration cabinet 161 and their respective components are separable units which can be handled separately for sales, maintenance or repair as necessary. A false cover 148 is provided for optional port exits to accommodate other sizes of containers 150. Outlet means for product such as the pipe nipple 174 and ball valve 182 are provided, preferably at the front of cabinet 158 in a position below the expected lower edge of jacket 106. Control box 156 is mounted atop at least two stir motor brackets 162 and CPC connector 120 provides electrical communication between controller panel 110 and components below in the cabinet housing. Control box 156 includes a control panel 110 for controlling various functions of the apparatus and a slotted vent 227 on its top. A representative control panel is shown in FIG. 4 of U.S. Pat. No. 6,276,264. Control systems, sensors and other components for this apparatus can be designed and assembled to control heat treating (such as pasteurization), heating and cooling processes as disclosed in this patent, particularly as in FIGS. 3, 4, 7 and 8 and in columns 6/7.

A shaft coupler 146 connects the stir motor (not shown here) to shaft 154 and propeller 108 (not seen here.) Details of shaft coupler 146 are provided below. Cabinet top 140 encloses the heat exchange jacket 106, container 150 and other mechanisms. Thermocouple cordgrip 118 is emplaced in cabinet top 140 below control box 156.

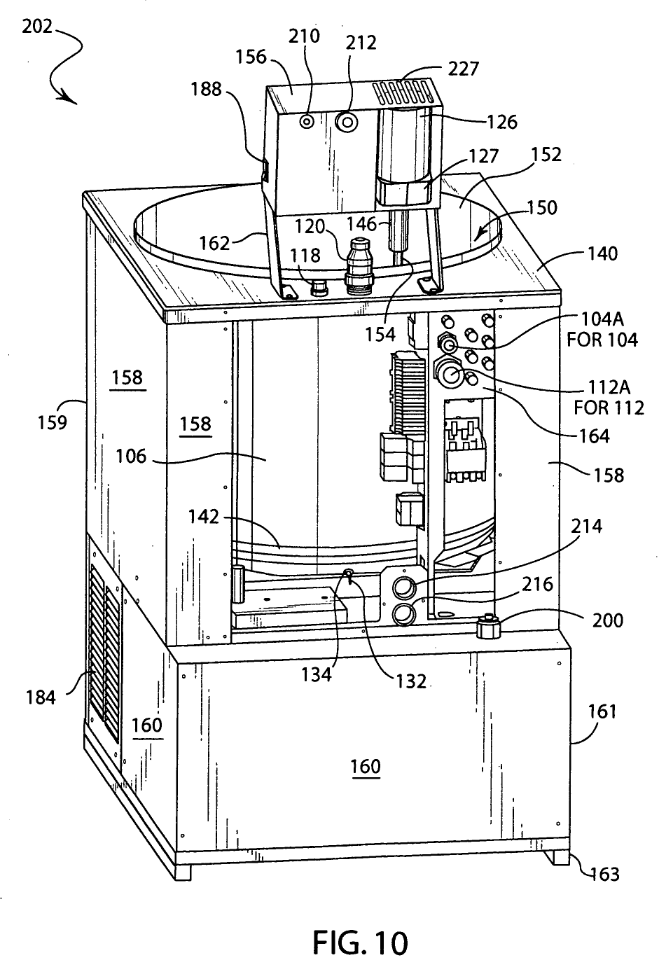

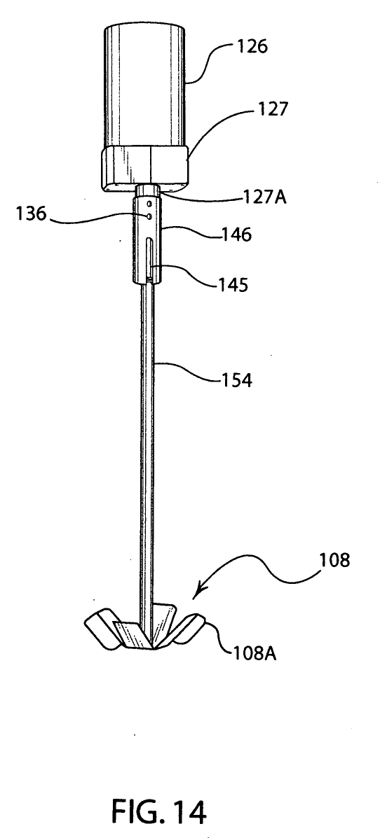

FIG. 8 illustrates the back of apparatus 202 with all covers and panels in place. A second filter screen 184 is on a panel 160 of refrigeration cabinet 161. Electrical wire grommets 210 and 212 are provided in the rear panel of control box 156 for thermocouple wires and a wire harness for controller panel 110, respectively. Reservoir port 200 at the rear top surface of refrigeration cabinet 161 is provided for filling the coolant reservoir 186, with a dipstick cap (not shown) for checking coolant level. Inlet 214 and outlet 216 are provided at the rear of main cabinet 159 for tap water when used for cooling. Inlet and outlet 214/216 can be connected to the inlet and outlet 107B/107A of cooling jacket 106 as required. A hole 119 in the rear panel 158 of cabinet 159 permits access to cord grips 114 and 116 and fuse holder 122, discussed below in FIG. 12.

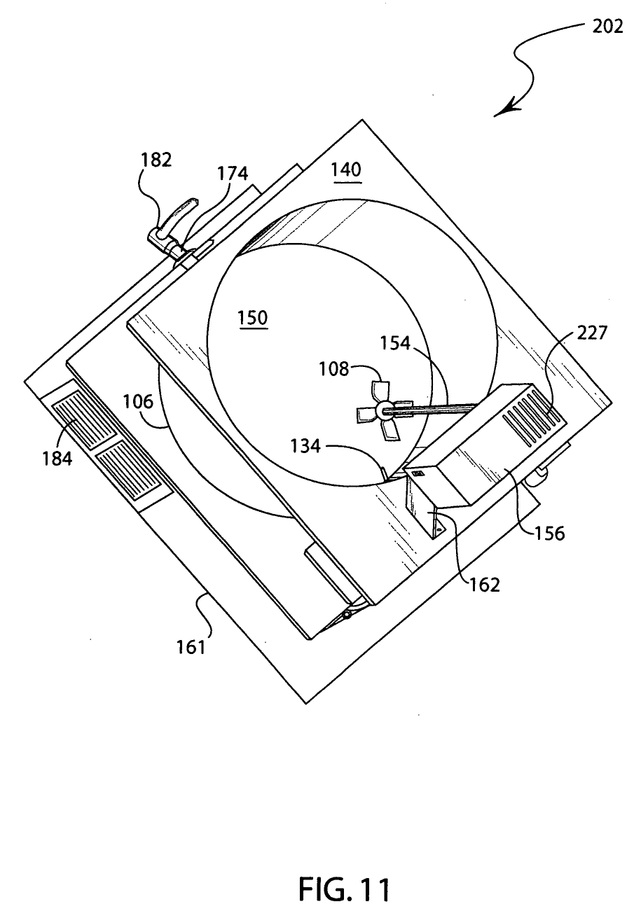

FIG. 9 illustrates the apparatus 202 with the upper cabinet panels 158 and the rear panel 160 of refrigeration unit cabinet 161 removed to illustrate working components. Chilled reservoir 186 is kept filled with a chilled cooling fluid (not shown) by the refrigeration unit 168, comprising condenser 198 and a Copeland compressor unit 222 (not visible). This fluid is normally a liquid such as water or synthetic liquids of higher heat capacity such as propylene glycol, but could be a gas or steam. Currently propylene glycol at 25 deg. F. is used for cooling. The choice of cooling or heat exchange fluids will take into consideration safety and health requirements for handling dairy products or other foodstuffs, as well as the characteristics of the rubber or other polymeric materials used in the heat exchange jacket 106. Filter screen 184, a duplicate of that on the other side of the unit, is visible, and a conventional refrigeration condenser unit 198 is partially visible inside refrigeration unit cabinet 161. An optional placement 148 for pipe nipple 174 on the front of the unit is also visible. At the top of the unit 202, stir motor 126, gearbox 127 and shaft coupler 146 are visible, mounted on motor brackets 162. Rocker switch 188 on the side of control box 156 is the power switch for the stirring and control unit. Motor 126 is an electric motor, preferably operating on 115 VAC and geared (through gearbox 127) to provide at least one suitable speed for stirring liquids to be treated. Further details are provided in the parts list attached as Appendix A. Slotted vent 227 is provided in the top of control box 156 to ventilate the motor.

Cooling jacket 106 is shown mounted around pot 150, with outer surface 106D visible with product outlet coupling 144 mounted below the expected lower edge of jacket 106 and connected to pipe nipple 174 and outlet valve 182. Utility plate 164 mounts control components of controller system 111, described below.

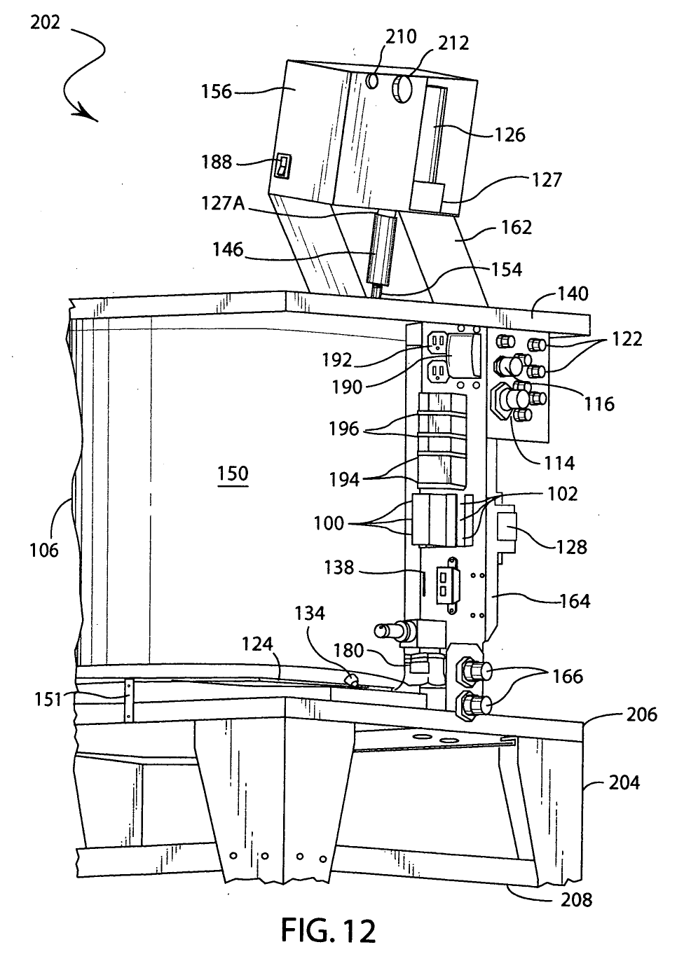

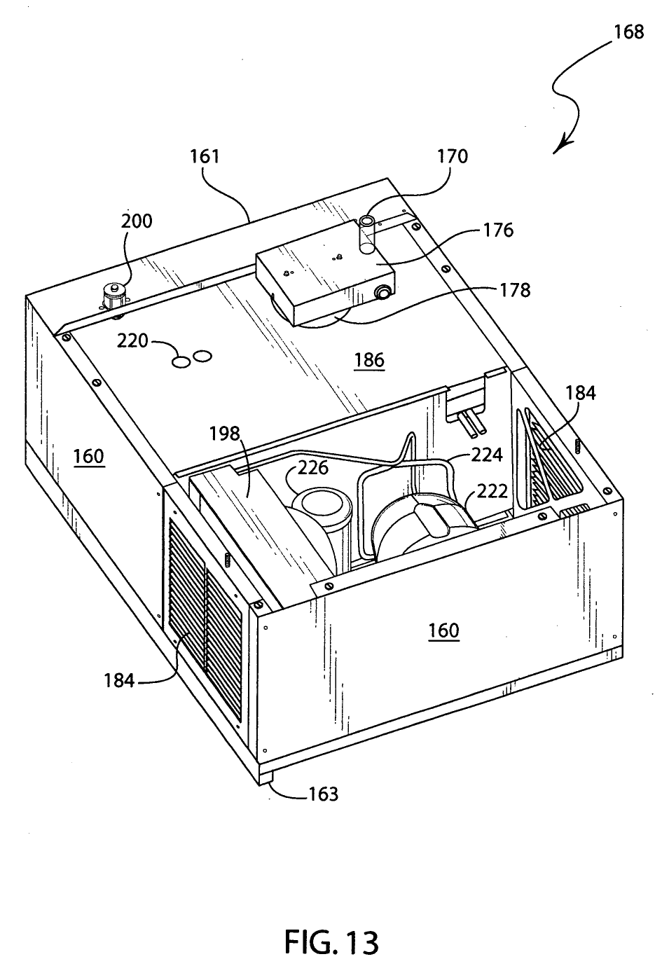

FIG. 10 shows the apparatus 202 with the back panel 158 of upper cabinet 159 removed. Motor 126 connects to shaft 154 via gearbox 127 and shaft coupler 146. Shaft 154 extends through pot lid 152, which retains heat and prevents spillage. Shafts 154 of selected lengths for different sizes of containers 150 or different products can be removably attached to coupler 146. Thermocouple cordgrip 118 receives a connection for thermocouple 132 (not visible here) and CPC coupling 120 provides for power connections between controller panel 110 and other components. Lid 152 covers pot 150. The back panel 158 of upper cabinet 159 is removed to reveal heat exchange jacket 106 which surrounds pot 150 and is secured with a large worm clamps 142 at top (not visible) and bottom. Thermocouple 132 fits through thermowell 134, shown in FIG. 11 near the bottom of container 150, to measure the temperature of liquid in pot 150. Reservoir port 200 provides for the introduction of a heat exchange fluid. A power cord 104A (usually 115 VAC, not shown here) connects to connection 104 to provide power to all components. Power cord 112A (220 VAC, not shown here) connects to connection 112 to supply optional large heater components, discussed below. Utility plate 164 holds various components which are discussed below.

FIG. 11 illustrates the unit 202 with pot lid 152 removed, revealing the inside of pot 150, the heat exchange jacket 106 on the exterior 106D thereof, and propeller 108 mounted on shaft 154. Thermowell 134 (containing thermocouple 132) is also visible. Pipe nipple 174 and ball valve 182 provide the outlet drain for container 150.

FIG. 12 illustrates the unit 202 with both upper and lower cabinet cases removed. Motor brackets 162 support control box 156, containing motor 126 and gearbox 127. Shaft coupler 146 connects motor 126 to shaft 154 via shaft 127. Shaft 154 for propeller 108 is mounted near the rear of the top opening of pot 150 and slanted slightly toward the center of container. While not essential, this provides more space for pouring liquid to be treated into container 150 while providing for good mixing of the liquid during treatment. Propeller 108 can be selected as described in U.S. Pat. No. 6,276,264. In this embodiment, propeller 108 has plural upturned vanes 108A. Although in present embodiments a single propeller shaft 154 is threaded into shaft coupler 146, which in turn is secured to the shaft (not shown here) of gearbox 127, making unidirectional rotation the preferred mode, this system can also be designed to operate in either direction, and multiple propellers or other types of impellers can be used, depending upon operational requirements.

A substantially cylindrical treatment container or pot 150 enclosed in heat exchange jacket 106 is mechanically attached atop plate heater 124 and supported by brackets 151 or other suitable mechanical means. In one embodiment, plate heater 124 is a “Hi-Heat” 220 VAC unit comprising a mica-edged foil heating element, but any suitable flat electrical heater can be included to provide heat for the contents of container 150 and connected with the control system as described above and in U.S. Pat. No. 6,276,264. Both cabinet top 140 and base 206 are connected to utility plate 164, which carries a number of electrical and control components which are discussed below. Base 206 is mounted on four legs 204, which are connected to leg support 208. Similar legs and supports can be used to support upper cabinet 158 if the unit is assembled without the refrigeration unit 201 or refrigeration cabinet 161, as illustrated in drawings A and B.

Fuses and fuse holders 122 are provided for both electrical supplies. Cordgrips 114 and 116 secure the incoming power cords. Cube relay 100 is attached to cube relay base 102. A 220 VAC contactor 128 can be used to connect or disconnect the heater 124 from power. Hose barbs 166 provide connections for intake and discharge of the heat exchange fluid, including optional tap water inputs, for heat exchange jacket 106, and can be opened and closed by solenoid valve 180. Thermowell 134 is visible at the bottom of container 150.

The components mounted on utility plate 164 make up the majority of the control system 111, which can be programmed to operate as described above and in U.S. Pat. No. 6,276,264. Duplex outlet 192 provides for supply and control of the pump and condenser 226 for refrigeration unit. Solid state relay 190 controls either heater 124 in 115 VAC embodiments or contactor 128 for 220 VAC heater embodiments. Ground terminal blocks 196 and power and neutral terminal blocks 194 provide for pass through wiring for various components of the control system. Cube relays 100 provide for control of components including pump(s), refrigeration unit and valves. Transformer 138 is connected to line voltage and provides 24 VAC to controller 110.

The control system components supported by utility plate 164 and elsewhere are configured substantially as described in U.S. Pat. No. 6,276,264, and can be programmed to carry out processes of pasteurization, other heat treatments, heating and/or cooling as required. Specifically, the apparatus 202 can receive a batch of milk or other dairy product to be pasteurized, heat it to a pasteurization temperature and retain it at that temperature for a predetermined period of time (as discussed for pasteurization cycles in the above patent), then cool it rapidly to a predetermined temperature for immediate use or cold storage. Simpler cycles such as the heating of liquids to a predetermined temperature and maintaining said temperature for predetermined times or indefinitely, or corresponding processes of cooling liquids such as fresh milk to predetermined temperatures for use or storage can be carried out. Based upon preliminary tests with prototypes, the rates of heating and/or cooling will be significantly faster than for apparatus disclosed in Applicant's U.S. Pat. No. 6,276,264 when treating comparable volumes of liquid. Additionally, the inherently insulating effects of the rubbery heat exchange jacket improve the efficiencies of both heating and cooling processes.

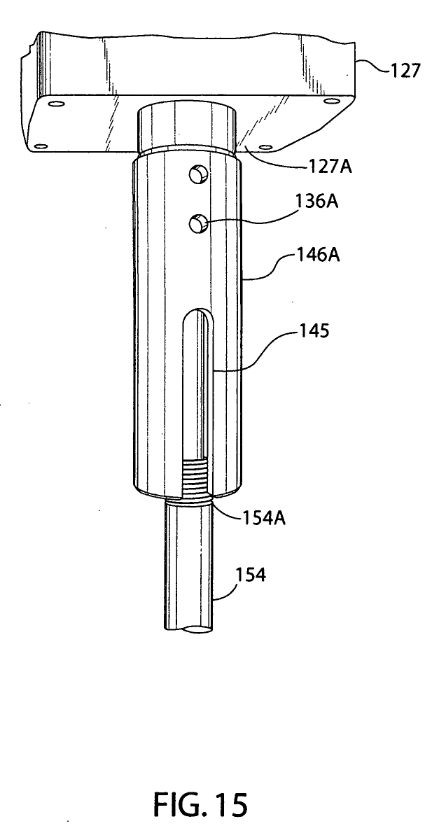

FIG. 13 shows refrigeration cabinet 161 and unit 168 without upper cabinet 158. This refrigeration unit 168, and the combined unit 202, is supported by footing rails 163, which can be made of wood, rubber, various polymeric materials or any suitable material. Heated air from the refrigeration process is discharged through screens 184 on both sides of cabinet 160. Reservoir port 200 is provided for filling or recycling of heat exchange fluid. Evaporator pump 178 is mounted underneath mounting bracket 176, extending downward into coolant reservoir 186 to evacuate coolant, discharging chilled heat exchange fluid via hose 170 into jacket inlet port 107B, finally returning the used fluid to reservoir 186 through ports 220. Condenser unit 198 is connected to compressor 222 via high pressure tubing 224 which forms an evaporator coil immersed in coolant reservoir 186 to remove heat from the circulating coolant. Condenser 222 is a Copeland condenser compressor unit, described in more detail in the parts list attached as Appendix A. Condenser 222 condenses the refrigerant (which can be any conventional refrigerant such as the Freon™ series, but is preferably an environmentally acceptable product) which has been vaporized by absorbing heat from the coolant, after which the condensate is recompressed by compressor 222 to carry on the cycle.

The simple apparatus discussed and illustrated above is designed to quickly chill milk or other liquids just coming from a cooking or pasteurizing process to lower temperatures for storage or use. In addition to or as alternatives to the refrigeration unit, a variety of systems can be used to provide chilled or heated heat exchange fluids for circulation through the heat exchange jacket. For example, hot water or other fluids can be provided by in-line heating or other means, as disclosed in FIG. 9 of U.S. Pat. No. 6,276,264, which is incorporated herein by reference. Chilled water can similarly be provided by any form of refrigeration unit, including passing through beds of ice, as disclosed in U.S. Pat. No. 6,276,264, which is incorporated herein by reference. For improved efficiency, albeit perhaps requiring more space, the refrigeration unit for chilling water can be configured to freeze water in an included container during off-power periods, producing ice which can be used to assist in chilling water for use in circulating through the unit at other times when the cooling process is underway. Such units can be produced by Ice Energy LLC of Ft. Collins, Colo.

In addition, the heat exchange jackets and control mechanisms disclosed above can be used for other purposes such as cooling exothermic chemical reactions, absorbing waste heat from a variety of processes and sources including internal combustion engines; maintenance of stable cooking temperatures, fermentation or other process temperatures.

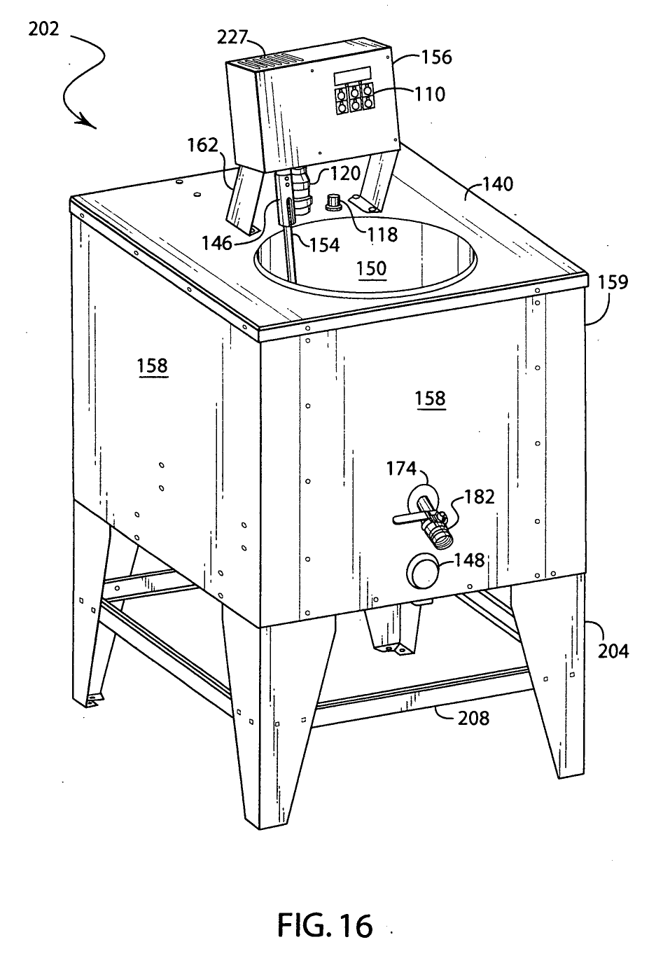

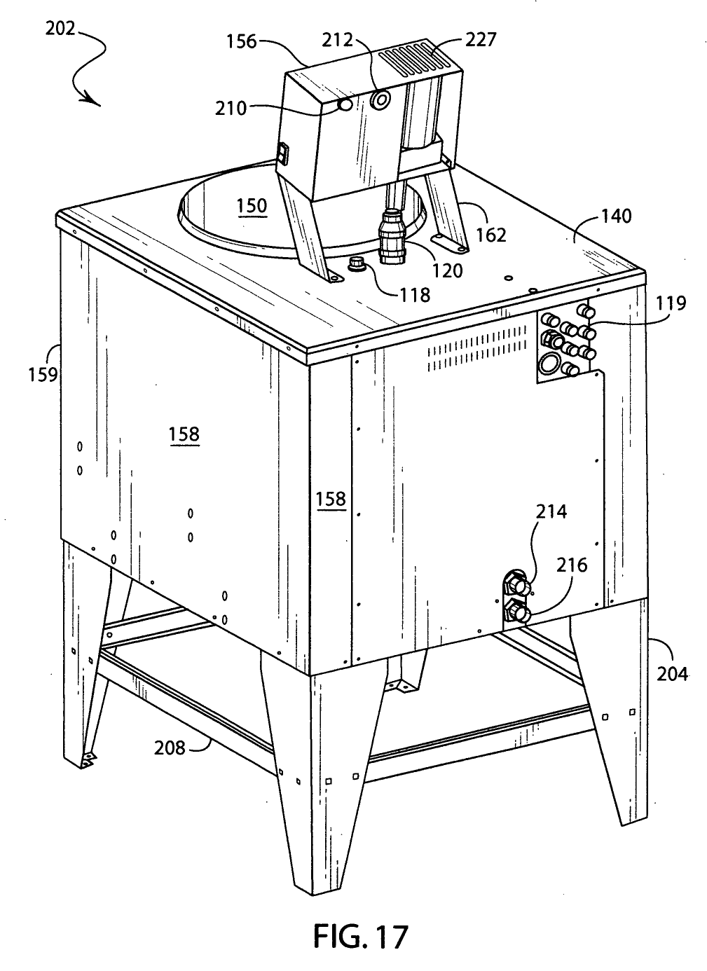

FIGS. 14 and 15 illustrate a preferred embodiment comprising a slotted and threaded shaft coupling. FIG. 14 illustrates the complete drive train. Motor 126 drives through gear box 127 to shaft 127A. Shaft coupler 146 is fabricated of aluminum, stainless steel or other suitable metal or material and is removably attached to shaft 127A using two or more set screws 136. Other suitable mechanical attachment devices can be used. Drive shaft 154, also aluminum or stainless steel, carries propeller 108, which has a plurality of upturned vanes 108A. FIG. 15 illustrates in detail threaded holes 136A in coupling 146 to receive set screws 136. A slot 145 is provided in the side of coupling 146 for the insertion of shaft 154, which carries external threads 154A. As discussed above, shafts 154 of different lengths, carrying at least one propeller having various characteristics of choice, can be installed interchangeably. Shafts 154 are installed by being inserted into the coupling 146 through slot 145, then pressed upward into the interior cavity of coupler 146 and screwed into place until threads 154A fully engage with interior threads within the cavity (not shown). The advantage of slot 145 in coupling 146 is that shaft-propeller assemblies which will nearly touch the bottom of container 150 when installed can be easily and quickly installed or removed even after set screws 136 are screwed into place to fully secure the coupling to motor shaft 127A. In this embodiment threads 154A are right hand threads, permitting clockwise rotation of shaft 154 (as viewed from above) to tend to tighten the shaft. If counter-clockwise rotation were desired, left hand threads could be employed. If a reversible motor or gear box were required, additional mechanical fasteners could be employed to retain shaft 154 in coupler 146 or a similar coupler.

Additional information is contained in the drawings attached as Appendix B (electronic media, disk containing CAD files in SolidWorks™), and in additional Sheets A through C of drawings which are not labeled with numerals.

Various changes and modifications to the presently preferred embodiments of the invention will be apparent to those skilled in the art. Such changes and modifications may be made without departing from the spirit and scope of the present invention and without diminishing its attendant advantages. Therefore, the appended claims are intended to cover such changes and modifications, and are the sole limits on the scope of the invention.

1. A heat exchanger jacket having a substantially rectangular form, adapted to be fitted about a substantial portion of the exterior surface of a cylindrical process container, including the entire circumference thereof, comprising a sheet of material having two lateral edges and two ends, with an inner surface and an outer surface, having at least one set of inlet and outlet means interconnected by fluid channels impressed in said inner surface, said channels being arranged and having suitable capacity to permit flows of a heat exchange fluid within said channels and directly against the outer surface of said process container when installed, to optimize heat transfer between said heat exchange fluid, said container and the contents thereof.

2. The heat exchanger jacket of claim 1 which is formed of a flexible, rubbery material which is selected to be resistant to effects of the maximum and minimum temperatures and chemical properties of said heat exchange fluid.

3. The heat exchanger jacket of claim 2 which forms an insulating barrier at the outer surface thereof when installed on a process container.

4. The heat exchange jacket of claim 1 wherein said fluid channels are formed and configured to allow substantially laminar flow of said heat exchange fluid through said channels and against the outer surfaces of said container when said jacket is attached around the circumference of said container.

5. The heat exchange jacket of claim 1 wherein said channels form at least one serpentine or helical pattern on said inner surface of said jacket to allow flow from one lateral edge of said jacket to the other.

6. The heat exchange jacket of claim 5 wherein said channels are configured to match at opposite ends of said jacket around said container, thereby describing a helical pattern from one edge of said jacket to the other and permitting continuous flow of said fluid from one edge to the other and around the circumference of said container without abrupt changes in direction.

7. A heat exchanger unit comprising a cylindrical container for the processing of liquids, a heat exchange jacket of claim 1 installed thereon, at least one source of heat exchange fluid operationally connected to the inlet and outlet means of said heat exchange jacket, control means for the flow, temperature and duration of flow of said heat exchange fluid and mixing means for the fluid processed within said container.

8. The heat exchanger unit of claim 7 which further comprises temperature sensing means for measuring the temperature in at least one location in a fluid within said container and communicating the temperatures measured to said control means.

9. The heat exchanger unit of claim 7 which further comprises temperature sensing means for measuring the temperature of said heat exchange fluid in at least one location in the fluid cycle and communicating the temperatures measured to said control means.

10. The heat exchanger unit of claim 8 wherein said source of heat exchange fluid comprises a vessel containing said heat exchange fluid, means for heating and/or cooling said fluid and pumping means to circulate said fluid at a desired temperature into said heat exchange jacket.

11. The heat exchanger unit of claim 10 wherein said means for cooling said heat exchange fluid include a refrigeration unit which chills heat exchange fluid from said vessel before it enters said heat exchange jacket.

12. The heat exchanger unit of claim 9 wherein said means for heating said heat exchange fluid comprise external heating means.

13. The heat exchanger unit of claim 7 which comprises additional means for heating said container and said liquid within same, comprising at least one of heating means within said liquid within said container or heating means below said container to heat the bottom thereof.

14. The heat exchanger unit of claim 13 wherein said heat exchange means within said liquid comprise electrical heating elements.

15. The heat exchanger unit of claim 13 wherein said heating means below said container comprise at least one electrical plate heater adjacent the bottom of said container.

16. The heat exchanger unit of claim 7 wherein said mixing means comprise at least one drive shaft, each carrying at least one propeller, immersed within said liquid within said container and rotated by driving means to mix said liquid.

17. The heat exchanger unit of claim 16 wherein said at least one drive shaft is driven by at least one electric motor.

18. The heat exchanger unit of claim 11 wherein said control means are programmed to heat a liquid within said container to a predetermined treatment temperature, maintain said temperature for a predetermined time, and cool the liquid after treatment to a predetermined temperature.

19. The heat exchanger unit of claim 18 which is adapted for use as a dairy pasteurizer and said control means are programmed to execute a pasteurization cycle for said liquid within said container.

20. Pasteurization apparatus comprising:
a cylindrical container for the pasteurization of liquids;
a heat exchange jacket having a substantially rectangular form which is fitted about a substantial portion of the external surface of said container, including the entire circumference thereof, said jacket having at least one set of inlet and outlet means interconnected by fluid channels impressed in the inner surface of said jacket, said channels being arranged and having suitable capacity to permit flows of a heat exchange fluid within said channels and directly against the outer surface of said container;
a source of heat exchange fluid comprising a vessel for containing said heat exchange fluid, means for heating and/or cooling said fluid, temperature sensing means for measuring the temperature of said heat exchange fluid in at least one location in the fluid cycle, and pumping means to circulate said heat exchange fluid at a desired temperature into said heat exchange jacket;
mixing means for the fluid processed within said container; and
control means for controlling the flow, temperature and duration of flow of said heat exchange fluid and said mixing means for the fluid processed within said container, said control means being programmed to execute a pasteurization cycle of heating the fluid within said container to a predetermined temperature for a predetermined time, then cooling said liquid within said container to a temperature for use or transport;
substantially all of said components and means recited herein being enclosed within a cabinet for said pasteurization apparatus.
